(19) United States
(12) Patent Application Publication
(10) Pub. No.: US 2012/0082490 A1
(43) Pub. Date: Apr. 5, 2012

(54) IMAGE FORMING APPARATUS

(75) Inventors: Dong Hyup SHIN, Seongnam-si (KR); Seung Kyu Lee, Hwaseong-si (KR); Jeong Yong Ju, Hwaseong-si (KR); Jun Ho Lee, Yongin-si (KR)

(73) Assignee: Samsung Electronics Co., Ltd., Suwon-si (KR)

(21) Appl. No.: 13/241,705

(22) Filed: Sep. 23, 2011

(30) Foreign Application Priority Data
Oct. 5, 2010 (KR) 10-2010-0097066

(51) Int. Cl. G03G 15/16

(52) U.S. Cl. 399/308

(57) ABSTRACT

An image forming apparatus includes a first conveyance path to guide a print medium from a pickup unit to a pair of conveyance rollers and a second conveyance path to guide the print medium from the conveyance rollers to a transfer device. The first conveyance path and the second conveyance path are curved in opposite directions so as to reduce vertical heights of the first and second conveyance paths and consequently, reduce a height of a main body of the image forming apparatus.

### CROSS-REFERENCE TO RELATED APPLICATIONS

This application claims priority under 35 U.S.C. 119 from Korean Patent Application No. 10-2010-0097066, filed on Oct. 5, 2010 in the Korean Intellectual Property Office, the disclosure of which is incorporated herein by reference in its entirety.

### BACKGROUND OF THE INVENTION

1. Field of the Invention

Embodiments of the present general inventive concept relate to an image forming apparatus having a main body formed with a conveyance path to convey a print medium, and particularly, to an image forming apparatus having a conveyance path formed to reduce a size of a main body thereof.

2. Description of the Related Art

An image forming apparatus is designed to form an image on a print medium. Examples of image forming apparatuses include printers, copiers, fax machines, and devices combining functions thereof.

In an electro-photographic image forming apparatus, after an exposure device irradiates light to a photoconductor, a surface of which has been changed, to form an electrostatic latent image on the surface of the photoconductor, developer is fed to the electrostatic latent image such that the electrostatic latent image is developed into a visible image. Then, a transfer device transfers the visible developer image from the photoconductor to a print medium and a fusing unit fuses the developer to the print medium.

### SUMMARY OF THE INVENTION

The present general inventive concept provides an image forming apparatus having a more compact outer appearance.

Additional aspects and advantages of the present general inventive concept will be set forth in part in the description which follows and, in part, will be obvious from the description, or may be learned by practice of the general inventive concept.

In accordance with aspects and utilities of the present general inventive concept, an image forming apparatus includes a print media storage unit to store print media, a pickup unit to pick up each print medium of the print media storage unit, a pair of conveyance rollers arranged above the pickup unit to face each other to convey the print medium picked up by the pickup unit, a transfer device to transfer developer to the print medium conveyed by the pair of conveyance rollers, a first conveyance path in a form of a curved path to guide the print medium picked up by the pickup unit so as to allow the print medium to move to the conveyance rollers above the pickup unit, and a second conveyance path having another form of another curved path in an opposite direction of the first conveyance pat to guide the print medium having passed through the conveyance rollers to the transfer device above the conveyance rollers.

The first conveyance path may change a movement direction of the print medium from a pickup direction, in which the print medium is picked up, to an opposite upward direction, and the second conveyance path may change the movement direction of the print medium from the opposite upward direction of the pickup direction to the pickup direction.

The image forming apparatus may further include a plurality of developing units to form visible images using developer, each of which includes a photoconductor provided with an electrostatic latent image, and the transfer device may include an intermediate transfer belt to which the developer of the photoconductors is transferred, a pair of rollers arranged at opposite insides of the intermediate transfer belt to provide rotation to the intermediate transfer belt, a first transfer roller arranged to face the photoconductor with the intermediate transfer belt interposed therebetween, and a second transfer roller arranged to face one of the pair of rollers with the intermediate transfer belt interposed therebetween, and the second conveyance path may guide the print medium to pass between the intermediate transfer belt and the second transfer roller.

The intermediate transfer belt may be obliquely oriented downward toward the second transfer roller.

The intermediate transfer belt may be obliquely oriented by an angle below 45 degrees with respect to a horizontal plane.

The pair of rollers may include a drive roller to rotate upon receiving rotational power from a drive source and a driven roller to rotate upon receiving rotational power from the driving roller via the intermediate transfer belt, and the driven roller may be arranged to face the second transfer roller.

The image forming apparatus may further include a fusing unit provided above the transfer device and serving to fuse the developer transferred to the print medium, and a print media discharge unit to discharge the print medium having passed through the fusing unit to the outside of the main body, and the driving roller may be located higher than the fusing unit and lower than the print media discharge unit.

The image forming apparatus may further include a fusing unit provided above the transfer device and serving to fuse the developer transferred to the print medium, and a third conveyance path to guide the print medium having passed through the transfer device to the fusing unit, and the third conveyance path may be curved to change a movement direction of the print medium having passed through the transfer device from a pickup direction in which the print medium is picked up to an opposite upward direction of the pickup direction.

The image forming apparatus may further include a first guide member arranged between the pair of conveyance rollers and the transfer device to define the second conveyance path, and a second guide member arranged between the transfer device and the fusing unit to define the third conveyance path, and a radius of curvature of the first guide member may be greater than a radius of curvature of the second guide member.

The pickup unit may include a pickup roller to pick up the print medium, a forward roller to convey the print medium picked up by the pickup roller to the first conveyance path, and a retard roller arranged to face the forward roller, a first nip is provided between the forward roller and the retard roller, and a second nip provided between the pair of conveyance rollers may be spaced apart from the first nip in the pickup direction in which the print medium is picked up.

The image forming apparatus may further include a plurality of developing units to form visible images using developer, each of which includes a photoconductor provided with an electrostatic latent image, and the transfer device may include an intermediate transfer belt, a driving roller and driven roller arranged at opposite insides of the intermediate transfer belt, a first transfer roller arranged to face the photoconductor with the intermediate transfer belt interposed therebetween, and a second transfer roller arranged to face one of the driving roller and the driven roller with the intermediate transfer belt interposed therebetween, and the second conveyance path may guide the print medium to pass between the intermediate transfer belt and the second transfer roller.

A third nip provided between the intermediate transfer belt and the second transfer roller may be spaced apart from a second nip, provided between the pair of conveyance rollers, in an opposite direction of the pickup direction in which the print medium is picked up.

The image forming apparatus may further include a plurality of developing units to form visible images using developer, each of which includes a photoconductor provided with an electrostatic latent image, and a fusing unit provided above the transfer device to fuse the developer transferred to the print medium, and the transfer device may include an intermediate transfer belt, a driving roller and driven roller arranged at opposite insides of the intermediate transfer belt, a first transfer roller arranged to face the photoconductor with the intermediate transfer belt interposed therebetween, and a second transfer roller arranged to face one of the driving roller and the driven roller with the intermediate transfer belt interposed therebetween, and the fusing unit may include a heating roller to generate heat and a pressure roller to press the print medium against an outer peripheral surface of the heating roller, and a vertical distance between a second nip provided between the pair of conveyance rollers and a third nip between the intermediate transfer belt and the second transfer roller may be greater than a fourth nip between the heating roller and the pressure roller and the third nip.

In accordance with another aspect and utilities of the present general inventive concept, an image forming apparatus includes a print media storage unit in which print media is stored, a pickup unit to pick up each print medium of the print media storage unit in a given direction, and a pair of conveyance rollers arranged to face each other to convey the print medium picked up by the pickup unit, the pickup unit includes a pickup roller to pick up the print medium, a forward roller to convey the print medium picked up by the pickup roller to a first conveyance path, and a retard roller arranged to face the forward roller, wherein a first nip is provided between the forward roller and the retard roller, and a second nip is provided between the pair of conveyance rollers to be spaced apart from the first nip in the pickup direction in which the print medium is picked up.

In accordance with a further aspect and utilities of the present general inventive concept, an image forming apparatus includes a plurality of developing units respectively including a plurality of photoconductors on which electrostatic latent images are formed, to develop the electrostatic latent images into visible images using developer, a transfer device to transfer the visible images formed on the plurality of photoconductors to a print medium, a fusing unit to fuse the developer, which has been transferred to the print medium, to the print medium, and a print media discharge unit provided above the fusing unit to discharge the print medium having passed through the fusing unit, the transfer device includes an intermediate transfer belt to which the developer of the photoconductors is transferred, a pair of rollers arranged inside opposite sides of the intermediate transfer belt, first transfer rollers arranged to face the photoconductors with the intermediate transfer belt interposed therebetween, and a second transfer roller arranged to face one of the pair of rollers with the intermediate transfer belt interposed therebetween, and the other one of the pair of rollers is located higher than the fusing unit and lower than the print media discharge unit.

In accordance with a further aspect and utilities of the present general inventive concept, an n image forming apparatus includes a print media storage unit to store print media, a pickup unit to pick up each print medium of the print media storage unit, a transfer unit to transfer an image to the print medium conveyed from the pickup unit, at a nip thereof, and a feeding unit formed with a zigzag line as a feeding path with respect to a line passing the nip of the transfer unit to feed the picked-up print medium to the transfer device.

The zigzag line may include a first path and a second path, and the first path and the second path are disposed opposite sides of the line.

The line may connects the pickup unit and the nip, the zigzag line may include a first curved line in a first direction and a second curved line in a second direction, and the first direction and the second direction may be opposite to each other with respect to the line.

The feeding unit may include first and second sets of rollers disposed between the transfer unit and the pickup unit, the first set of rollers may have a first nip with a first tangential line direction away from the transfer unit, the second set of rollers may have a second nip with a second tangential line direction toward the transfer unit, and the first tangential line direction and the second tangential line direction may be disposed opposite to each other with respect to the line.

The transfer unit may include an intermediate transfer belt with the image as a developer image, rollers disposed opposite to each other with respect to each other, and a transfer roller to face one of the rollers through the immediate transfer belt and to form the nip with the one of the rollers.

The image forming apparatus may further include a fusing unit disposed to fuse the image transferred on the print medium, and the fusing unit may be disposed lower than the other one of the rollers and higher than the one of the rollers.

The rollers may have rotation axes disposed on a line, and the transfer roller may have a rotation axis disposed on another line different from the line of the rotation axes of the rollers.

### BRIEF DESCRIPTION OF THE DRAWINGS

These and/or other aspects of the general inventive concept will become apparent and more readily appreciated from the following description of the embodiments, taken in conjunction with the accompanying drawings of which:

FIG. 1 is a schematic view of an image forming apparatus in accordance with an embodiment of the present general inventive concept;

FIGS. 2 and 3 are enlarged views illustrating a print media conveyance path for the image forming apparatus in accordance with one embodiment of the present general inventive concept;

FIG. 4 is an enlarged view illustrating a print media conveyance path for the image forming apparatus in accordance with another embodiment of the present general inventive concept;

FIG. 5 is a schematic view of an image forming apparatus in accordance with a further embodiment of the present general inventive concept;

FIGS. 6A, 6B, and 6C are view illustrating a transfer device of the image forming apparatus of FIG. 1 according to an embodiment of the present general inventive concept;

FIGS. 7A and 7B are views illustrating a feeding path having a plurality of tangential line directions as a traveling direction of the print medium in the image forming apparatus of FIG. 1 according to an embodiment of the present general inventive concept; and

FIGS. 8A, 8B, and 8C are views illustrating a feeding path traveling along a zigzag line with respect to a line of a nip of the transfer unit in the image forming apparatus of FIG. 1 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

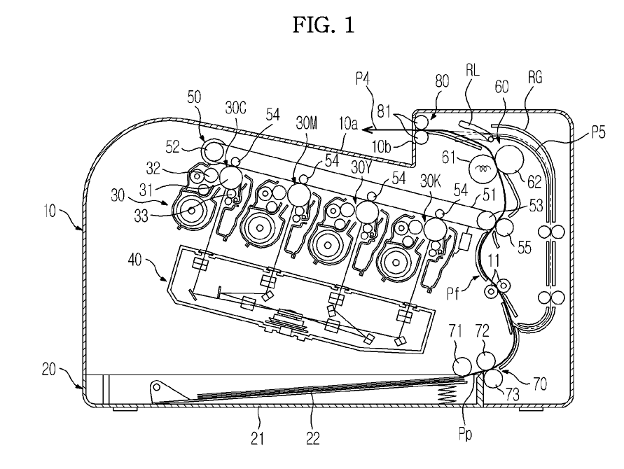

As illustrated in FIG. 1, the image forming apparatus in accordance with the embodiment of the present general inventive concept includes a main body 10, which defines an external appearance of the image forming apparatus, a print media storage unit 20, a plurality of developing units 30C, 30M, 30Y and 30K to feed developer to an electrostatic latent image formed on a surface of a photoconductor 31 to develop the electrostatic latent image into a visible image, an exposure unit 40 to form the electrostatic latent image on the surface of the photoconductor 31 of each developing unit 30C, 30M, 30Y or 30K which has been charged, a transfer device (or transfer unit) 50 to transfer the visible image formed on the photoconductor 31 to a print medium conveyed from the print media storage unit 20, and a fusing unit 60 to fuse the developer, which has been transferred to the print medium, to the print medium.

The main body 10 includes a deck 10a, on which the print media containing a completely formed image (transferred image) is discharged and loaded, and a print media discharge port 10b, through which the print media containing the completely formed image is discharged toward the deck 10a.

The print media storage unit 20 includes a print media cassette 21 to be inserted into the main body 10 through an opening of the main body 10 and then movably installed in (detachably attached to) the main body 10 in a direction of the main body 10 such that print media can be picked and fed toward the transfer device 30, and a knock-up plate 22 placed in the print media cassette 21 to support print media thereon.

Each of the developing units 30C, 30M, 30Y and 30K includes the photoconductor 31, a surface of which has been provided with an electrostatic latent image formed by the exposure unit 40, the photoconductor 31 serving as an image carrier containing a visible image formed using developer, a developing roller 32 to feed developer to the photoconductor 31 so as to develop the electrostatic latent image of the photoconductor 31 into the visible image, a charge roller 33 to charge the surface of the photoconductor 31. In the present embodiment, the developing units 30C, 30M, 30Y and 30K are four developing units arranged side by side in a left-and-right direction to develop Cyan, Magenta, Yellow and Black colors.

The exposure unit 40 irradiates light corresponding to image information to the photoconductors 31 respectively provided in the plurality of developing units 30C, 30M, 30Y and 30K, thereby forming electrostatic latent images on the surfaces of the respective photoconductors 31.

The transfer device 50 includes an intermediate transfer belt 51, to which the visible developer images formed on the photoconductors 31 are transferred, a pair of rollers 52 and 53 disposed inside the intermediate transfer belt 51 and arranged at opposite ends of the intermediate transfer belt 51 to support rotation of the intermediate transfer belt 51, first transfer rollers 54 arranged to face the photoconductors 31 of the developing units 30C, 30M, 30Y and 30K with the intermediate transfer belt 51 interposed therebetween, the first transfer rollers 54 serving to transfer the visible images of the photoconductors 31 to the intermediate transfer belt 51, and a second transfer roller 55 arranged to face one of the two rollers 52 and 53 with the intermediate transfer belt 51 interposed therebetween, the second transfer roller 55 serving to transfer the visible image of the intermediate transfer belt 51 to a print medium. The pair of rollers 52 and 53 may include a driving roller 52 to rotate upon receiving rotational power from a drive source (not illustrated), such as a motor, and a driven roller 53 to receive upon receiving rotational power via the intermediate transfer belt 51, the driven roller 53 being arranged to face the second transfer roller 55. However, the present general inventive concept is not limited thereto. It is possible that the pair of rollers 52 and 53 may include a driven roller 52 and a driving roller 53. In this case, the driving roller 53 is arranged to face the second transfer roller 55 through the intermediate transfer belt 51.

The fusing unit 60 includes a heating roller 61 to generate heat, and a pressure roller 62, an outer peripheral surface of which is made of an elastically deformable material, the pressure roller 62 serving to press the print medium against an outer peripheral surface of the heating roller 61.

The main body 10 further accommodates a pickup unit 70 placed on one side of the print media storage unit 20 to pick up the print media stacked on the knock-up plate 22 sheet by sheet, a pair of conveyance rollers 11 arranged above the pickup unit 70 to upwardly guide the print medium picked up by the pickup unit 70 to the transfer device 50, and a print media discharge unit 80 arranged above the fusing unit 60 at a position close to the print media discharge port 10b so as to discharge the print medium having passed through the fusing unit 60 through the discharge port 10b.

The pickup unit 70 includes a pickup roller 71 to pick up the print media placed on the knock-up plate 22 sheet by sheet along a pickup path Pp, by coming into contact with each print medium, a forward roller 72 to move the print medium conveyed from the pickup roller 71 toward the conveyance rollers 11, and a retard roller 73 arranged to face the forward roller 72 to prevent simultaneous movement of a plurality of sheets of print media during picking up a sheet at a time.

The conveyance rollers 11 include a pair of conveyance rollers arranged to face each other such that the print medium passes between the two conveyance rollers 11 along a feeding path Pf disposed between the pickup path Pp and a discharge path P4.

The print media discharge unit 80 includes a pair of discharge rollers 81 arranged inside the print media discharge port 10b of the main body 10. With rotation of the discharge rollers 81, the print medium having passed through the fusing unit 60 is discharged through the print media discharge port 10b along the discharge path P4. In this case, the discharge rollers 81 are rotatable forward or in reverse and may return the print medium, on a surface of which an image has been completely formed, to the transfer device 50 via a return path P5 defined by return guide members RL and RG.

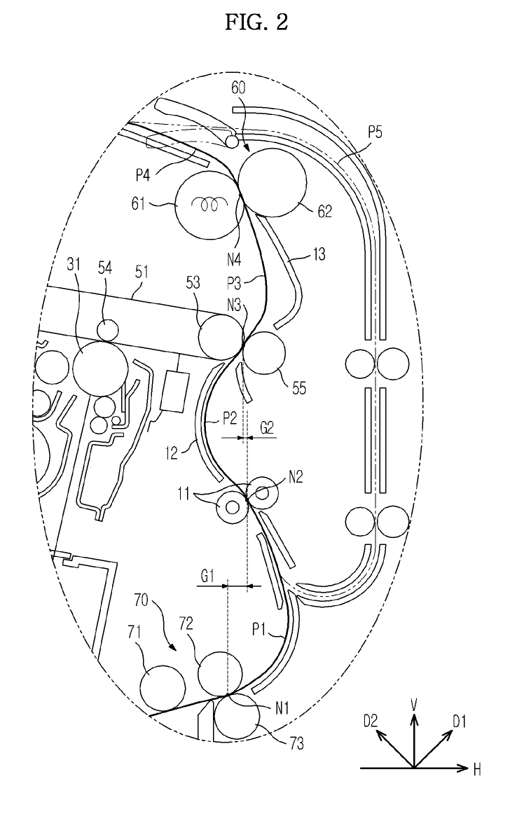

The main body 10, as illustrated in FIG. 2, has a structure to define a first conveyance path P1 to guide the print medium having passed through the pickup unit 70 to the conveyance rollers 11 above the pickup unit 70, a second conveyance path P2 to guide the print medium having passed through the conveyance rollers 11 to the transfer device 50 above the conveyance roller 11, a third conveyance path P3 to guide the print medium having passed through the transfer device 50 to the fusing unit 60 above the transfer device 50, the print medium containing the developer transferred to one surface thereof, the discharge path P4 connected to the third conveyance path P3 to guide the print medium having passed through the fusing unit 60 to the print media discharge port 10b, the print medium containing the developer image completely formed on the surface thereof, and the return path P5 connected to the first conveyance path P1 to guide the print medium, on the surface of which the image has been completely formed, to the fusing unit 60 by way of the first conveyance path P1. In the present embodiment, the second conveyance path P2 guides the print medium to pass between the intermediate transfer belt 51 and the second transfer roller 55.

The feeding path Pf may include the first conveyance path P1, the second conveyance path P2, and the third conveyance path P3 which are disposed between the pickup path Pp and the discharge path P4.

The first conveyance path P1 and the second conveyance path P2 are curved in opposite directions. The first conveyance path P1 and the second conveyance path P2 may have substantially an S-shaped form as illustrated in FIG. 2. A lower portion of the S-shape may correspond to the first conveyance path P1, and an upper portion of the S-shape may correspond to the second conveyance path P2. With this configuration, the first conveyance path P1 and the second conveyance path P2 may have reduced vertical heights with respect to a bottom or top of the main body 10 while maintaining predetermined lengths thereof. This serves to reduce the height of the main body 10 and provide the main body 10 of the image forming apparatus with a more compact appearance.

The first conveyance path P1 guides the print medium, which has been picked up by the pickup unit 70 and moved in an upward pickup direction D1, such that a movement direction of the print medium is changed from the pickup direction D1 to an opposite upward direction D2. The second conveyance path P2 guides the print medium, which has moved in the opposite upward direction D2 of the pickup direction D1, such that the movement direction of the print medium is changed to the upward pickup direction Dl. Also, the third conveyance path P3 guides the print medium such that the movement direction of the print medium is again changed from the upward pickup direction D1 to the opposite upward direction D2.

The upward direction D1 may have a right horizontal direction component and an upward vertical direction component in a horizontal component H and a vertical component V, respectively. The opposite upward direction D2 may be opposite to the upward direction D1 with respect to a vertical direction, and may have a left horizontal direction component and an upward vertical direction component in the horizontal component H and the vertical component V, respectively.

A first nip N1 is provided between the forward roller 72 and the retard roller 73, a second nip N2 is provided between the two conveyance rollers 11, a third nip N3 is provided between transferring rollers, such as the intermediate transfer belt 51 and the second transfer roller 55, and a fourth nip N4 is provided between fixing rollers, such as the heating roller 61 and the pressure roller 62. The first conveyance path P1 extends between the first nip N1 and the second nip N2, the second conveyance path P2 extends between the second nip N2 and the third nip N3, and the third conveyance path P3 extends between the third nip N3 and the fourth nip N4.

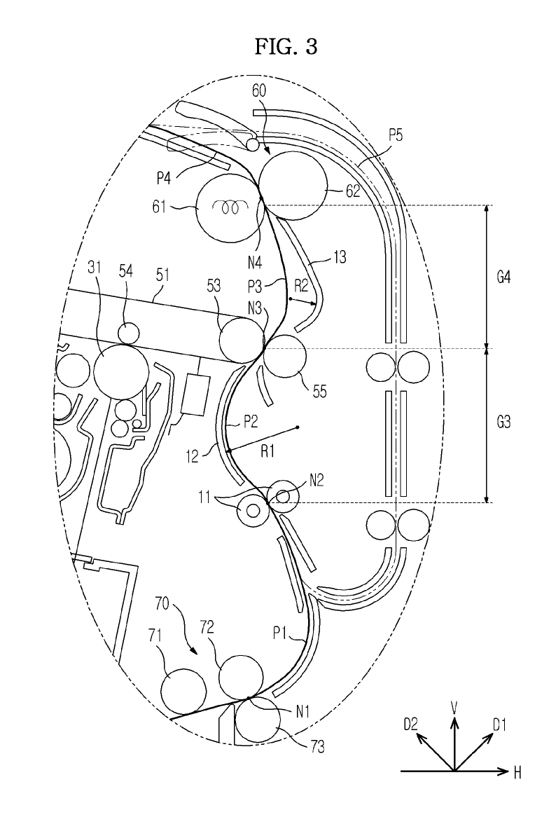

In the present embodiment, the second nip N2 is spaced apart from the first nip N1 in the horizontal component of the pickup direction D1 by a first distance G1, and the third nip N3 is spaced apart from the second nip N2 in the horizontal component of the opposite direction D2 of the pickup direction D1 by a second distance G2. Also, as illustrated in FIG. 3, a vertical distance G3 between the second nip N2 and the third nip N3 is greater than a vertical distance G4 between the third nip N3 and the fourth nip N4 in the vertical component. when the height of the fusing unit 60 is lowered with respect to a bottom of the main body 10, the height of the main body 10 is lowered and/or the size of the main body 10 becomes smaller.

A plurality of guide members 12 and 13 is installed in the main body 10 to allow the print medium to move along the conveyance paths P1, P2 and P3. The guide members 12 and 13 include a first guide member 12 arranged between the conveyance rollers 11 and the transfer device 50 to define the second conveyance path P2, and a second guide member 13 arranged between the transfer device 50 and the fusing unit 60 to define the third conveyance path P3. In this case, since the vertical distance G3 between the second nip N2 and the third nip N3 is greater than the vertical distance G4 between the third nip N3 and the fourth nip N4 as described above, a radius of curvature R1 of the first guide member 12 is greater than a radius of curvature R2 of the second guide member 13.

The first guide member 12 may have a structure or shape to form the second conveyance path P2 which corresponds to the upper portion of the S-shape, and the second guide member 13 may have a structure or shape to form the third conveyance path P3, which corresponds to a C-shape extended from an upper end of the S-shape of the second conveyance path P2.

Referring back to FIG. 1, in the present embodiment, the intermediate transfer belt 51 of the transfer device 50 is obliquely oriented downward toward the second transfer roller 55. This serves to reduce a left-and-right width of the intermediate transfer belt 51 occupying an internal space of the main body 10 in the horizontal component, and consequently, reduce a left-and-right width of the main body 10. If the intermediate transfer belt 51 has an angle below 45 or more with respect to the horizontal component, installation of the intermediate transfer belt 51 may require an increased height of the main body 10. Therefore, the angle between the intermediate transfer belt 51 and the horizontal plane may be less than 45 degrees.

As described above, the second transfer roller 55 is arranged to face the driven roller 53 with the intermediate transfer belt 51 interposed therebetween and therefore, the intermediate transfer belt 51 is obliquely oriented such that one side of the intermediate transfer belt 51 facing the driven roller 53 is lower than the other side thereof in the vertical component.

Also, since the driving roller 52 is arranged inside the other side of the intermediate transfer belt 51, the driving roller 52 may be located higher than the fusing unit 60 but lower than the print media discharge unit 80 according to shapes and positions of the deck 10a and the print media discharge port 10b of the main body 10.

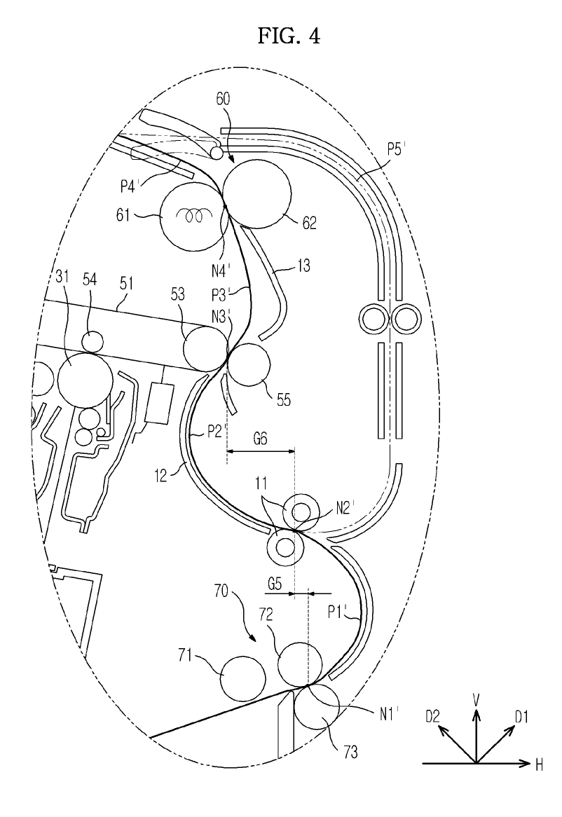

FIG. 4 illustrates an image forming apparatus in accordance with another embodiment of the present general inventive concept.

The image forming apparatus in accordance with the secondly described embodiment is configured in such a manner that the pickup unit 70 is installed close to a lateral surface of the main body 10 to the maximum extent, which may further reduce a left-and-right width of the main body 10 in the horizontal component.

With this arrangement of the pickup unit 70, a second nip N2′ is spaced apart from a first nip N1′ in the opposite direction D2 of the pickup direction D1 by a fifth distance G5 in the horizontal component, and a third nip N3′ is spaced apart from the second nip N2′ in the opposite direction D2 of the pickup direction D1 by a sixth distance G6 in the horizontal component.

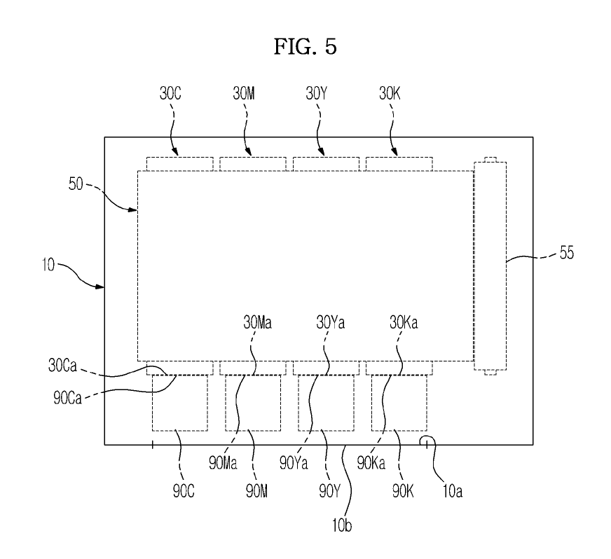

The developing units 30C, 30M, 30Y and 30K according to the above-described embodiments are configured to store developer therein, but are not limited thereto. In a further embodiment of the present general inventive concept as illustrated in FIG. 5, developer storage units 90C, 90M, 90Y and 90K in which developer to be fed to the developing units 30C, 30M, 30Y and 30K is stored may be provided separately from the developing units 30C, 30M, 30Y and 30K.

In the present embodiment, the developing units 30C, 30M, 30Y and 30K are arranged below the transfer device 50 and the developer storage units 90C, 90M, 90Y and 90K are arranged at corresponding sides of the developing units 30C, 30M, 30Y and 30K, i.e. at a side of the transfer device 50 so as to feed developer to the corresponding developing units 30C, 30M, 30Y and 30K.

Connection portions 30Ca, 30Ma, 30Ya, and 30Ka of the developer storage units 90C, 90M, 90Y and 90K are connected or fixed to corresponding portions 90Ca, 90Ma, 90Ya, and 90Ka formed on the respective developing units 30C, 30M, 30Y and 30K. Since the developer storage units 90C, 90M, 90Y and 90K are disposed outside an area of the transfer device 50, the developer storage units 90C, 90M, 90Y and 90K can be installed to be connected to the corresponding developing units 30C, 30M, 30Y and 30K without interference of the transfer device 50 or without causing damage on the transfer device or other internal structures of the main body 10.

The developer storage units 90C, 90M, 90Y and 90K may be a consumable or replaceable component and detachably attached to the corresponding side portions of the of the developing units 30C, 30M, 30Y and 30K. Also the developer storage units 90C, 90M, 90Y and 90K are disposed outside an area of the transfer device 50. Accordingly, when the developer is used up and a new developer is required, the developer storage units 90C, 90M, 90Y and 90K are detached from or attached to the corresponding developing units 30C, 30M, 30Y and 30K through an opening 10a of the main body 10 in a removing, replacing, or attaching operation. A cover 10b may be formed on the main body 10 to correspond to the opening 10a thereof. In this case, the structure of the transfer device 50 does not block, prevent, or interfere with the removal and installation of the developer storage units 90C, 90M, 90Y and 90K.

When the developer storage units 90C, 90M, 90Y and 90K are provided separately from the developing units 30C, 30M, 30Y and 30K and are arranged at the side of the transfer device 50, the developing units 30C, 30M, 30Y and 30K have no space for developer storage, which may reduce the height of the developing units 30C, 30M, 30Y and 30K and consequently, reduces the height of the main body 10 according to the reduced height of the developing units 30C, 30M, 30Y and 30K, resulting in a more compact image forming apparatus.

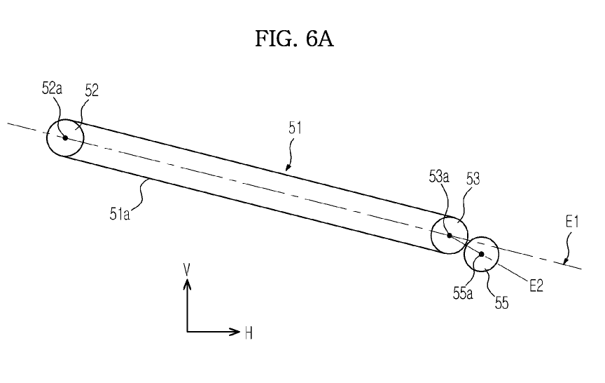

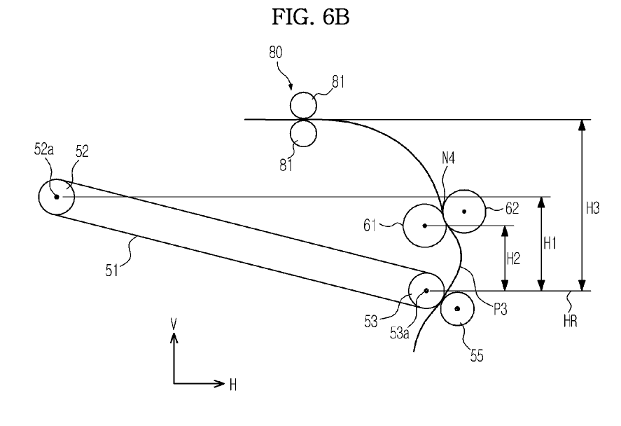

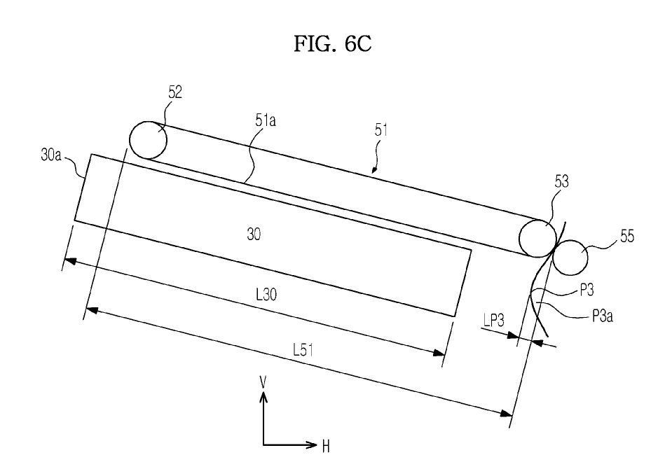

Referring to FIG. 6A, the rollers 52 and 53 may have rotations axes 52a and 53a disposed on a line E1 connecting the rotation axes 52a and 53a. A rotation axis 55a of the second transfer roller 55 may not be disposed on the line E1. The rotation axis 55a of the second transfer roller 55 may be disposed on a line E2 connecting the rotation axis 53a of the roller 53 and the rotation axis 55a of the second transfer roller 55. The line E1 may have an angle with the line E2 with respect to the rotation axis 53a of the roller 53.

Referring to FIG. 6B, the rotation axis 52a of the roller 52 are disposed to be higher than a reference line HR by a height H1 in a direction parallel to the vertical component V. The reference line HR passes the rotation axis 53a of the roller 53 and may be parallel to the horizontal component H. The nip N4 of the rollers 61 and 62 of the fusing unit 60 may be disposed to be higher than the reference line HR by a second height H2, and a nip of the rollers 81 of the discharge unit 80 may be disposed to be higher than the reference line HR by a third height H3. The first height H1 may be higher than the second height H2 and/or lower than the third height H3.

Referring to FIG. 6C, a major surface 51a of the intermediate transfer belt 51 is inclined with respect to a direction of the vertical component V and/or the horizontal component H. The major surface 51a may be a portion of the intermediate transfer belt 51 disposed to receive images from the developing unit 30. The intermediate transfer belt 51 may be disposed in an area corresponding to a length L51 in a lengthwise direction of the major surface 51a of the intermediate transfer belt 51. The developing unit 30 may be disposed in an area corresponding to a length 30. The length 30 of the developing unit 30 may overlap with the length L51. The third path P3 may be disposed to overlap with the length L51 by an area corresponding to a length LP3. The length L30 of the developing unit L30 may not overlap with the length LP3 of the third path P3. However, the present general inventive concept is not limited thereto. The lengths L30, L51, and LP3 may be changed to overlap with one another according to design or arrangement of the units in the main body 10.

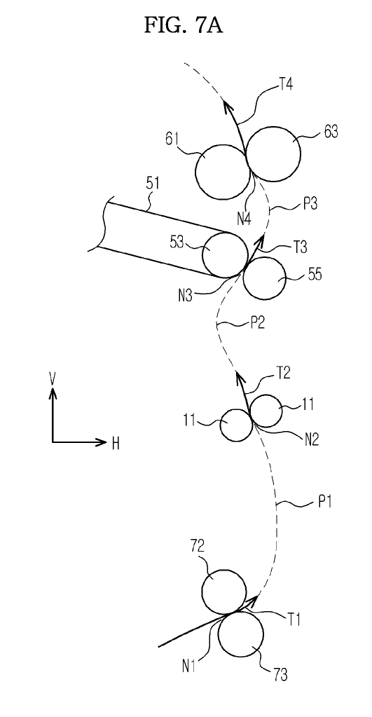

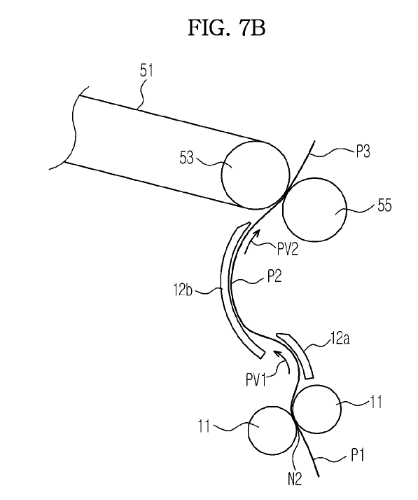

Referring to FIG. 7A, first, second, third, and fourth tangential directions T1, T2, T3, and T4 of the sets of rollers 72 and 73, 11, 53 and 55, and 61 and 63 are formed in the corresponding nips N1, N2, N3, and N4. The first tangential direction T1 may be disposed in a direction away from the intermediate transfer belt 51, and the second tangential direction T2 may be disposed in a direction toward the intermediate transfer belt 51. The first tangential direction T1 are opposite to the second tangential direction T2 with respect to the vertical component V and/or the horizontal component H.

Referring to FIG. 7B, the guide member 12 may include guide members 12a and 12b. The guide member 12a receives the print medium from the nip N2 of the rollers 11 and bends (or directs) the received print medium such that a leading edge of the print medium moves toward a portion of the developing unit 30 or the intermediate transfer belt 51. The guide member 12b receives the bent or directed print medium from the guide member 12a and then bends (or directs) the leading edge of the print medium moves toward the nip N3 of the rollers 53 and 55. The guide member 12b may be longer than the guide member 12a.

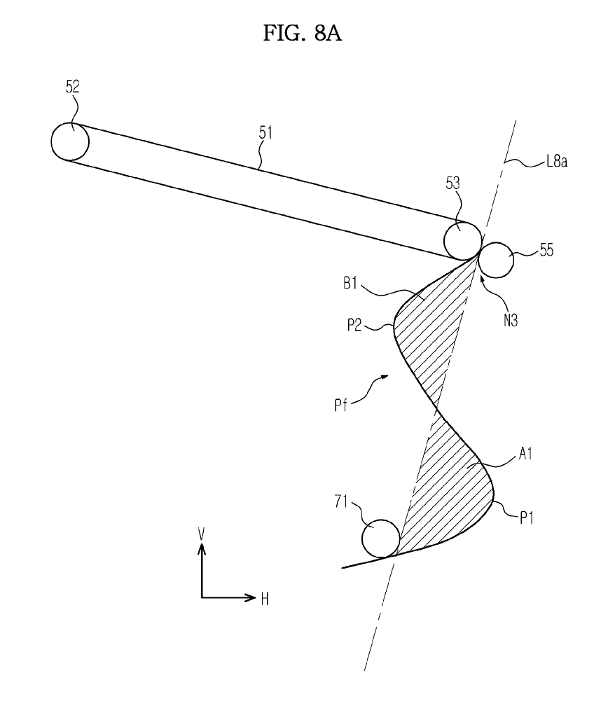

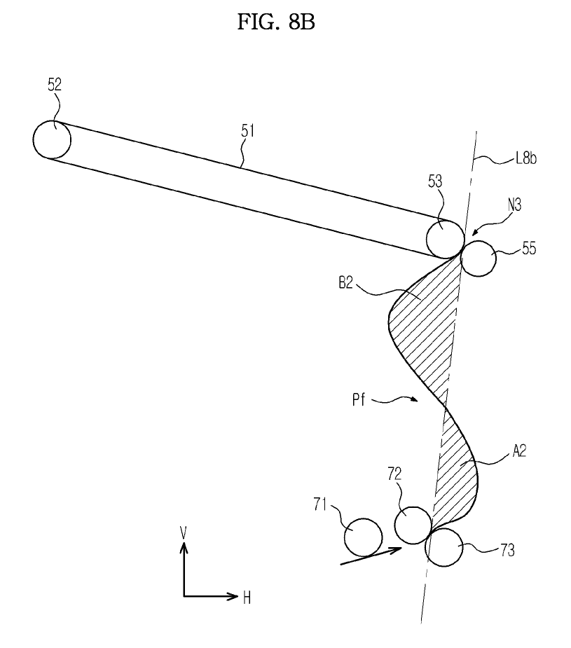

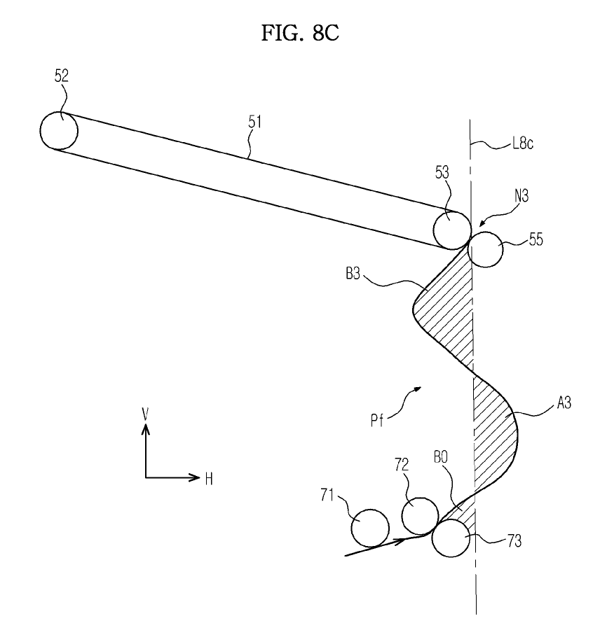

Referring to FIG. 8A, the nip N3 of the rollers 53 and 55 may form a line L8a with the pickup roller 71. The line L8a may have an angle with the vertical component V and/or the horizontal component H. However, the present general inventive concept is not limited thereto. It is possible that the line L8a may be parallel to the vertical component V. The feeding path Pf is disposed in opposite sides of the line L8a such that the feeding path Pf moves in a zigzag line with respect to the line L8a and such that the print medium moves along the zigzag line with respect to the line L8a. That is, the first path P1 is disposed in an area A1 and the second path P2 is disposed in an area B1, as illustrated in FIG. 8A. The areas A1 and B1 are disposed opposite to each other with respect to the line L8a.

Referring to FIG. 8B, the nip N3 of rollers 53 and 55 may form a line L8b with the nip N1 of the rollers 72 and 73. The line L8b may have an angle with the vertical component V and/or the horizontal component H. However, the present general inventive concept is not limited thereto. It is possible that the line L8b may be parallel to the vertical component V. The feeding path Pf is disposed in opposite sides of the line L8b such that the feeding path Pf moves in a zigzag line with respect to the line L8b and such that the print medium moves along the zigzag line with respect to the line L8b. That is, the first path P1 is disposed in an area A2 and the second path P2 is disposed in an area B2, as illustrated in FIG. 8B. The areas A2 and B2 are disposed opposite to each other with respect to the line L8b.

Referring to FIG. 8C, the nip N3 of rollers 53 and 55 may form a line L8c in a direction substantially parallel to the vertical component V. The feeding path Pf is disposed in opposite sides of the line L8c such that the feeding path Pf moves in a zigzag line with respect to the line L8c and such that the print medium moves along the zigzag line with respect to the line L8c. That is, an initial path B0 of the picked print medium is disposed in an area B0, the first path P1 is disposed in an area A3 and the second path P2 is disposed in an area B3, as illustrated in FIG. 8C. The areas A3 and B3 are disposed opposite to each other with respect to the line L8c, and the areas B0 and B3 are disposed on a same side of the line L8c.

As is apparent from the above description, the embodiments of the present general inventive concept provide an image forming apparatus in which a first conveyance path and a second conveyance path are curved in opposite directions, which may reduce vertical heights of the first and second conveyance paths while maintaining predetermined lengths thereof. This results in a reduced height of a main body and a more compact outer appearance of the image forming apparatus.

Although the embodiment of the present general inventive concept has been shown and described, it would be appreciated by those skilled in the art that changes may be made in these embodiments without departing from the principles and spirit of the invention, the scope of which is defined in the claims and their equivalents.

What is claimed is:

1. An image forming apparatus comprising:
a print media storage unit to store print media;
a pickup unit to pick up each print medium of the print media storage unit;
a pair of conveyance rollers arranged above the pickup unit to face each other to convey the print medium picked up by the pickup unit;
a transfer device to transfer developer to the print medium conveyed by the pair of conveyance rollers;
a first conveyance path having a form of a curved path in a direction to guide the print medium picked up by the pickup unit so as to allow the print medium to move to the conveyance rollers above the pickup unit; and
a second conveyance path having another form of another curved path in an opposite direction of the first conveyance pat to guide the print medium having passed through the conveyance rollers to the transfer device above the conveyance rollers.

2. The apparatus according to claim 1, wherein:
the first conveyance path changes a movement direction of the print medium from a pickup direction, in which the print medium is picked up, to an opposite upward direction; and
the second conveyance path changes the movement direction of the print medium from the opposite upward direction of the pickup direction to the pickup direction.

3. The apparatus according to claim 1, further comprising a plurality of developing units to form visible images using developer, each of which includes a photoconductor provided with an electrostatic latent image,
wherein the transfer device includes an intermediate transfer belt to which the developer of the photoconductors is transferred, a pair of rollers arranged at opposite insides of the intermediate transfer belt to assist the intermediate transfer belt in rotating, a first transfer roller arranged to face the photoconductor with the intermediate transfer belt interposed therebetween, and a second transfer roller arranged to face one of the pair of rollers with the intermediate transfer belt interposed therebetween, and
wherein the second conveyance path guides the print medium to pass between the intermediate transfer belt and the second transfer roller.

4. The apparatus according to claim 3, wherein the intermediate transfer belt is obliquely oriented downward toward the second transfer roller.

5. The apparatus according to claim 4, wherein the intermediate transfer belt is obliquely oriented by an angle below 45 degrees with respect to a horizontal plane.

6. The apparatus according to claim 4, wherein:
the pair of rollers includes a drive roller to rotate upon receiving rotational power from a drive source and a driven roller to rotate upon receiving rotational power from the driving roller via the intermediate transfer belt; and
the driven roller is arranged to face the second transfer roller.

7. The apparatus according to claim 6, further comprising:
a fusing unit provided above the transfer device to fuse the developer transferred to the print medium; and
a print media discharge unit to discharge the print medium having passed through the fusing unit to an outside of the main body,
wherein the driving roller is located higher than the fusing unit and lower than the print media discharge unit.

8. The apparatus according to claim 1, further comprising:
a fusing unit provided above the transfer device to fuse the developer transferred to the print medium; and
a third conveyance path to guide the print medium having passed through the transfer device to the fusing unit,
wherein the third conveyance path is curved to change a movement direction of the print medium having passed through the transfer device from a pickup direction in which the print medium is picked up to an opposite upward direction of the pickup direction.

9. The apparatus according to claim 8, further comprising:
a first guide member arranged between the pair of conveyance rollers and the transfer device to define the second conveyance path; and
a second guide member arranged between the transfer device and the fusing unit to define the third conveyance path,
wherein a radius of curvature of the first guide member is greater than a radius of curvature of the second guide member.

10. The apparatus according to claim 1, wherein:
the pickup unit includes a pickup roller to pick up the print medium, a forward roller to convey the print medium picked up by the pickup roller to the first conveyance path, and a retard roller arranged to face the forward roller; and
a first nip is provided between the forward roller and the retard roller and a second nip provided between the pair of conveyance rollers is spaced apart from the first nip in the pickup direction in which the print medium is picked up.

11. The apparatus according to claim 1, further comprising:
a plurality of developing units to form visible images using developer, each of which includes a photoconductor provided with an electrostatic latent image,
wherein the transfer device includes an intermediate transfer belt, a driving roller and driven roller arranged at opposite insides of the intermediate transfer belt, a first transfer roller arranged to face the photoconductor with the intermediate transfer belt interposed therebetween, and a second transfer roller arranged to face one of the driving roller and the driven roller with the intermediate transfer belt interposed therebetween, and
wherein the second conveyance path guides the print medium to pass between the intermediate transfer belt and the second transfer roller.

12. The apparatus according to claim 11, wherein a second nip is provided between the pair of conveyance rollers, a third nip is provided between the intermediate transfer belt and the second transfer roller, and the third nip is spaced apart from the second nip in an opposite direction of the pickup direction in which the print medium is picked up.

13. The apparatus according to claim 1, further comprising:
a plurality of developing units to form visible images using developer, each of which includes a photoconductor provided with an electrostatic latent image; and
a fusing unit provided above the transfer device and serving to fuse the developer transferred to the print medium,
wherein the transfer device includes an intermediate transfer belt, a driving roller and driven roller arranged at opposite insides of the intermediate transfer belt, a first transfer roller arranged to face the photoconductor with the intermediate transfer belt interposed therebetween, and a second transfer roller arranged to face one of the driving roller and the driven roller with the intermediate transfer belt interposed therebetween, and
wherein the fusing unit includes a heating roller to generate heat and a pressure roller to press the print medium against an outer peripheral surface of the heating roller, and
wherein a vertical distance between a second nip provided between the pair of conveyance rollers and a third nip between the intermediate transfer belt and the second transfer roller is greater than a fourth nip between the heating roller and the pressure roller and the third nip.

14. An image forming apparatus comprising:
a print media storage unit to store print media;
a pickup unit to pick up each print medium of the print media storage unit in a given direction; and
a pair of conveyance rollers arranged to face each other to convey the print medium picked up by the pickup unit,
wherein the pickup unit includes a pickup roller to pick up the print medium, a forward roller to convey the print medium picked up by the pickup roller to a first conveyance path, and a retard roller arranged to face the forward roller, and
wherein a first nip is provided between the forward roller and the retard roller, and a second nip is provided between the pair of conveyance rollers to be spaced apart from the first nip in a pickup direction in which the print medium is picked up.

15. The apparatus according to claim 14, further comprising:
a transfer device arranged above the pair of conveyance rollers to transfer developer to the print medium conveyed by the pair of conveyance rollers,
wherein the transfer device includes an intermediate transfer belt, a pair of rollers arranged inside opposite sides of the intermediate transfer belt, a first transfer roller arranged to face the photoconductor with the intermediate transfer belt interposed therebetween, and a second transfer roller arranged to face one of the pair of rollers with the intermediate transfer belt interposed therebetween, and
wherein a third nip provided between the intermediate transfer belt and the second transfer roller is spaced apart from the second nip in an opposite direction of the pickup direction.

16. The apparatus according to claim 15, further comprising:
a fusing unit provided above the transfer device and serving to fuse the developer transferred to the print medium,
wherein the fusing unit includes a heating roller to generate heat and a pressure roller to press the print medium against an outer peripheral surface of the heating roller, and
wherein a fourth nip provided between the heating roller and the pressure roller is spaced apart from the third nip in the pickup direction.

17. The apparatus according to claim 16, wherein a distance between the second nip and the third nip is greater than the third nip and the fourth nip.

18. An image forming apparatus comprising:
a plurality of developing units respectively including a plurality of photoconductors on which electrostatic latent images are formed, and to develop the electrostatic latent images into visible images using developer;
a transfer device to transfer the visible images formed on the plurality of photoconductors to a print medium;
a fusing unit to fuse the developer, which has been transferred to the print medium, to the print medium; and
a print media discharge unit provided above the fusing unit to discharge the print medium having passed through the fusing unit,
wherein the transfer device includes an intermediate transfer belt to which the developer of the photoconductors is transferred, a pair of rollers arranged at opposite insides of the intermediate transfer belt, first transfer rollers arranged to face the photoconductors with the intermediate transfer belt interposed therebetween, and a second transfer roller arranged to face one of the pair of rollers with the intermediate transfer belt interposed therebetween, and
wherein the other one of the pair of rollers is located higher than the fusing unit and lower than the print media discharge unit.

19. The apparatus according to claim 18, wherein the intermediate transfer belt is obliquely oriented downward toward the second transfer roller.

20. The apparatus according to claim 19, wherein the intermediate transfer belt is obliquely oriented by an angle below 45 degrees with respect to a horizontal plane.

21. The apparatus according to claim 19, further comprising:
a plurality of developer storage units in which developers to be fed to the plurality of developing units are stored respectively,
wherein the plurality of developing units is arranged below the transfer unit, and
wherein the plurality of developer storage units is arranged at the side of the transfer unit.

22. An image forming apparatus comprising:
a print media storage unit to store print media;
a pickup unit to pick up each print medium of the print media storage unit;
a transfer unit to transfer an image to the print medium conveyed from the pickup unit, at a nip thereof; and
a feeding unit formed with a zigzag line as a feeding path with respect to a line passing the nip of the transfer unit to feed the picked-up print medium to the transfer device.

23. The image forming apparatus of claim 22, wherein the zigzag line includes a first path and a second path, and the first path and the second path are disposed opposite sides of the line.

24. The image forming apparatus of claim 22, wherein:
the line connects the pickup unit and the nip;
the zigzag line includes a first curved line in a first direction and a second curved line in a second direction; and
the first direction and the second direction are opposite to each other with respect to the line.

25. The image forming apparatus of claim 22, wherein:
the feeding unit comprises first and second sets of rollers disposed between the transfer unit and the pickup unit;
the first set of rollers have a first nip with a first tangential line direction away from the transfer unit;
the second set of rollers have a second nip with a second tangential line direction toward the transfer unit; and
the first tangential line direction and the second tangential line direction are disposed opposite to each other with respect to the line.

26. The image forming apparatus of claim 22, wherein the transfer unit comprises:
an intermediate transfer belt with the image as a developer image;
rollers disposed opposite to each other with respect to each other; and
a transfer roller to face one of the rollers through the immediate transfer belt and to form the nip with the one of the rollers.

27. The image forming apparatus of claim 26, further comprising:
a fusing unit disposed to fuse the image transferred on the print medium,
wherein the fusing unit is disposed lower than the other one of the rollers and higher than the one of the rollers.

28. The image forming apparatus of claim 26, wherein the rollers have rotation axes disposed on a line, and the transfer roller has a rotation axis disposed on another line different from the line of the rotation axes of the rollers.
